(19) United States
(12) Patent Application Publication
(10) Pub. No.: US 2020/0292741 A1
(43) Pub. Date: Sep. 17, 2020

(54) ELECTRONIC DEVICE EQUIPPED WITH OPTICAL FINGERPRINT SENSOR

(71) Applicant: Samsung Electronics Co., Ltd., Gyeonggi-do (KR)

(72) Inventors: Bong Jae RHEE, Gyeonggi-do (KR); Kem Suk SEO, Gyeonggi-do (KR); Sun A KIM, Gyeonggi-do (KR); Chi Hyun CHO, Gyeonggi-do (KR)

(21) Appl. No.: 16/650,073

(22) PCT Filed: Sep. 21, 2018
(86) PCT No.: PCT/KR2018/011261

§ 371 Date: Mar. 24, 2020

(30) Foreign Application Priority Data
Sep. 27, 2017 (KR) 10-2017-0125129

(51) Int. Cl. G02B 5/30; G02B 5/02; G06K 9/00; G06F 3/041

(52) U.S. Cl. CPC G02B 5/3066; G02B 5/0294; G06F 3/0412; G06F 3/04182; G06K 9/0004

(57) ABSTRACT

Disclosed is an electronic device including a transparent member, a display that is disposed under the transparent member and that includes a plurality of pixels, an image sensor disposed under at least a partial area of the display, and an optical path layer disposed between the at least a partial area and the image sensor. The optical path layer includes an incident path of light that is formed such that, when light output through the plurality of pixels is reflected from the transparent member and an external object in contact with the transparent member, light reflected from the external object is delivered to the image sensor and light reflected from the transparent member is interrupted. Besides, it may be permissible to prepare various other embodiments speculated through the specification.

### TECHNICAL FIELD

Embodiments of the disclosure relate to an electronic device including an optical fingerprint sensor.

### BACKGROUND ART

Electronic devices, such as mobile devices including smartphones, have become necessities of modern life, and technologies related to user authentication for protection of personal information have been actively developed.

Fingerprint recognition technology is included in most commonly used user authentication technologies. An electronic device including a fingerprint sensor to which the fingerprint recognition technology is applied may authenticate a user by comparing fingerprint information collected during user authentication with fingerprint information registered through a fingerprint registration process.

Meanwhile, in recent years, with an increase in the number of users who prefer large screens, research and development have been consistently conducted to increase the size of a screen in an electronic device such as a smartphone. For example, an electronic device may be equipped with an infinity display that occupies almost the entire front surface of the electronic device.

The electronic device equipped with the infinity display has no non-display area such as a bezel or has a small non-display area, and therefore a fingerprint sensor that is generally disposed in the non-display area may be disposed in a display area of a screen. Furthermore, an optical fingerprint sensor may be disposed in the display area of the screen, and thus a light source (e.g., a back light unit (BLU), a light emitting diode (LED), an organic light emitting diode (OLED), or the like) that is included in a display may be used without needing to dispose a separate light source for the optical fingerprint sensor.

### DISCLOSURE

### Technical Problem

However, in the case where the optical fingerprint sensor is disposed in the display area of the screen, it may be difficult to obtain a clear fingerprint image due to an optical characteristic (e.g., reflectivity) of a cover glass that forms the front exterior of the electronic device.

Embodiments of the disclosure may provide an electronic device including an optical fingerprint sensor for decreasing the amount of light reflected from the surface of a cover glass so as to be less affected by an optical characteristic of the cover glass.

Furthermore, embodiments of the disclosure may provide an electronic device including an optical fingerprint sensor for generating a three-dimensional fingerprint image to obtain a clearer fingerprint image.

### Technical Solution

An electronic device according to an embodiment of the disclosure includes a transparent member, a display that is disposed under the transparent member and that includes a plurality of pixels, an image sensor disposed under at least a partial area of the display, and an optical path layer disposed between the at least a partial area and the image sensor. The optical path layer includes an incident path of light that is formed such that, when light output through the plurality of pixels is reflected from the transparent member and an external object in contact with the transparent member, light reflected from the external object is delivered to the image sensor and light reflected from the transparent member is interrupted.

Furthermore, an electronic device according to an embodiment of the disclosure includes a housing, a cover glass that forms the exterior of at least one surface of the housing, a display located inside the housing and under the cover glass and exposed through a first area of the cover glass, and an optical fingerprint sensor located inside the housing and under the display and, when viewed from above the cover glass, placed in a position aligned with a second area of the cover glass that is included in the first area. The optical fingerprint sensor includes an image sensor and an optical path layer located at the top of the image sensor, and the optical path layer has an incident path of light that is formed such that a chief ray angle (CRA) of light incident on the image sensor matches Brewster angle determined based on the cover glass and an air layer.

In addition, an electronic device according to an embodiment of the disclosure includes a housing, a cover glass that forms the exterior of at least one surface of the housing, a polarizer located inside the housing and under the cover glass, a polarization direction of the polarizer being a first direction, a display located inside the housing and under the polarizer and exposed through a first area of the cover glass, and an optical fingerprint sensor located inside the housing and under the display and, when viewed from above the cover glass, placed in a position aligned with a second area of the cover glass that is included in the first area. The optical fingerprint sensor includes an image sensor and an optical path layer located at the top of the image sensor. The optical path layer has an incident path of light that is formed such that a chief ray angle (CRA) of light incident on the image sensor matches Brewster angle determined based on the cover glass and an air layer. The image sensor includes a plurality of first pixels corresponding to the optical path layer having the incident path of light that is directed in a second direction and a plurality of second pixels corresponding to the optical path layer having the incident path of light that is directed in a third direction different from the second direction.

### Advantageous Effects

According to the embodiments of the disclosure, the electronic device including the optical fingerprint sensor may decrease the amount of light reflected from the surface of the cover glass, thereby obtaining a clearer fingerprint image and thus improving a fingerprint recognition rate.

Furthermore, the electronic device including the optical fingerprint sensor may obtain a three-dimensional fingerprint image, thereby raising a fingerprint recognition rate and may easily distinguish a counterfeit fingerprint image, thereby improving the reliability of fingerprint recognition.

In addition, the disclosure may provide various effects that are directly or indirectly recognized.

### DESCRIPTION OF DRAWINGS

FIG. 1 is a view illustrating an electronic device including an optical fingerprint sensor according to an embodiment of the disclosure;

FIG. 2 is an exploded perspective view of the electronic device according to an embodiment of the disclosure;

FIG. 3 is a side sectional view of the electronic device according to an embodiment of the disclosure;

FIG. 4A is a view illustrating Brewster angle according to an embodiment of the disclosure;

FIG. 4B is a view illustrating Brewster angle depending on characteristics of mediums according to an embodiment of the disclosure;

FIG. 4C is a view illustrating reflection of light from a cover glass according to an embodiment of the disclosure;

FIG. 5A is a sectional view of the optical fingerprint sensor adjusting an incident path of light using a micro lens according to an embodiment of the disclosure;

FIG. 5B is a sectional view of the optical fingerprint sensor adjusting an incident path of light using a pin hole according to an embodiment of the disclosure;

FIG. 5C is a sectional view of the optical fingerprint sensor adjusting an incident path of light using a masked pin hole according to an embodiment of the disclosure;

FIG. 6A is a view illustrating the amount of incident light in a case of having a plane of incidence of light parallel to a polarization direction according to an embodiment of the disclosure;

FIG. 6B is a view illustrating the amount of incident light in a case of having a plane of incidence of light perpendicular to a polarization direction according to an embodiment of the disclosure;

FIG. 7 is a view illustrating a method of obtaining a fingerprint image using an optical fingerprint sensor having an incident path of light parallel to a polarization direction and an optical fingerprint sensor having an incident path of light perpendicular to the polarization direction according to an embodiment of the disclosure;

FIG. 8A is a view illustrating optical fingerprint sensors having incident paths of light in different directions according to an embodiment of the disclosure;

FIG. 8B is a view illustrating a method of obtaining a fingerprint image using the optical fingerprint sensors having the incident paths of light in the different directions according to an embodiment of the disclosure;

FIG. 9A is a view illustrating optical fingerprint sensors having incident paths of light in different directions according to an embodiment of the disclosure;

FIG. 9B is a view illustrating a method of obtaining a fingerprint image using the optical fingerprint sensors having the incident paths of light in the different directions according to an embodiment of the disclosure;

FIG. 10 is a view illustrating a pixel of an optical fingerprint sensor including a plurality of sub-pixels according to an embodiment of the disclosure;

FIG. 11 is a view illustrating a pixel of an optical fingerprint sensor including a plurality of sub-pixels according to an embodiment of the disclosure;

FIG. 12 is a view illustrating optical fingerprint sensors having incident paths of light in different directions parallel to a polarization direction according to an embodiment of the disclosure; and

FIG. 13 is a block diagram of an electronic device in a network environment according to various embodiments.

With regard to the description of the drawings, identical or similar reference numerals may be used to refer to identical or similar components.

### MODE FOR INVENTION

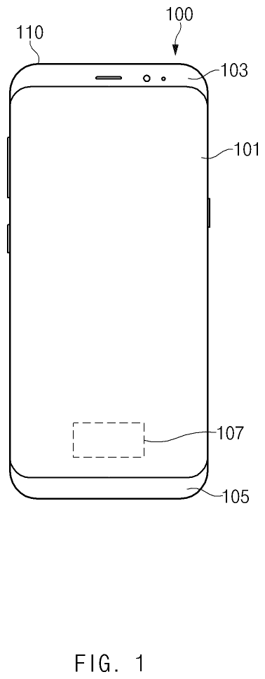

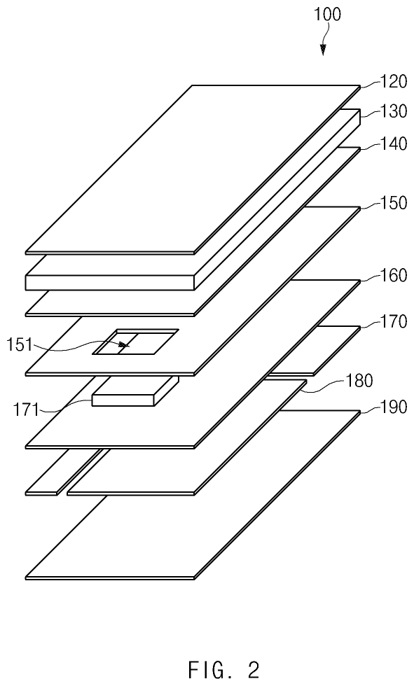

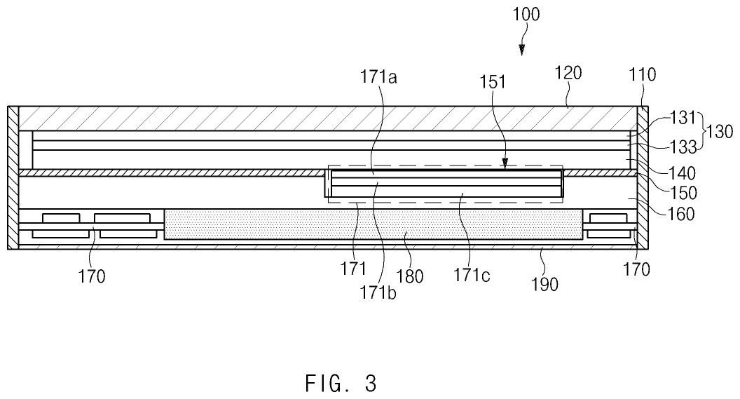

FIG. 1 is a view illustrating an electronic device including an optical fingerprint sensor according to an embodiment of the disclosure, FIG. 2 is an exploded perspective view of the electronic device according to an embodiment of the disclosure, and FIG. 3 is a side sectional view of the electronic device according to an embodiment of the disclosure.

Referring to FIGS. 1 to 3, the electronic device 100 according to an embodiment may include a housing 110, a cover glass 120, an intermediate layer 130, a display 140, a back panel 150, a bracket 160, a printed circuit board 170, the optical fingerprint sensor 171, a battery 180, and a back cover 190. However, a configuration of the electronic device 100 is not limited thereto. According to various embodiments, the electronic device 100 may not include at least one of the aforementioned components and may further include at least one other component(s).

The housing 110 may include a first surface (hereinafter, referred to as a front surface) that faces a first direction, a second surface (hereinafter, referred to as a rear surface) that faces a second direction opposite to the first direction, and side surfaces that surround part of a space between the front surface and the rear surface. In this disclosure, the side surfaces refer to surfaces that are visually seen when a thin side of the electronic device 100 is viewed, the front surface refers to a surface through which a screen output through the display 140 is exposed to the outside, except for the side surfaces, and the rear surface refers to a surface opposite to the front surface. In some embodiments, part of the screen of the display 140 may be exposed to the outside through the rear surface and/or the side surfaces, but the front surface, unlike the rear surface and/or the side surfaces, may be implemented such that almost the entire area thereof outputs the screen of the display 140. For example, almost the entire area of the front surface may be implemented as a display area 101, and partial areas of the front surface may be implemented as non-display areas 103 and 105. FIG. 1 illustrates a state in which the first non-display area 103 is located on an upper side of the display area 101 and the second non-display area 105 is located on a lower side of the display area 101. According to an embodiment of the disclosure, at least one of the first non-display area 103 or the second non-display area 105 may be omitted. For example, depending on the type of the electronic device 100, at least one of the first non-display area 103 or the second non-display area 105 may be omitted, and the display area 101 may extend to the omitted area.

Referring to FIG. 2, the cover glass 120 may cover part of the exterior of the electronic device 100 to protect at least one component (e.g., the display 140) mounted in a housing (e.g., the housing 110 of FIG. 1) from the outside. According to an embodiment, the cover glass 120 may be combined with the housing 110 having a space therein in which components of the electronic device 100 are received. For example, the cover glass 120 may form at least part of the front surface of the electronic device 100. In another example, the cover glass 120 may form the entire front surface of the electronic device 100. In another example, the cover glass 120 may form the front surface and a part of the side surfaces of the electronic device 100. The cover glass 120 may be formed to be a substantially flat surface, and at least a part of an upper end, a lower end, a left end, and/or a right end of the cover glass 120 may be formed to be a curved surface. At least a partial area of the cover glass 120 may be formed of a transparent material (or a transparent member), and the screen output through the display 140 may be displayed to the outside through the transparent area of the cover glass 120. For example, the cover glass 120 may be formed of a material such as reinforced glass, plastic (e.g., PET), aluminum oxide, or the like.

The intermediate layer 130 may include a bonding sheet 131 and a polarizer (or a polarizing filer) 133. For example, the bonding sheet 131 may bond the polarizer 133 to the cover glass 120. The polarizer 133 may include a linear polarizer film or a circular polarizer film. For example, the polarizer 133 may polarize incident light.

The display 140 may be disposed under the cover glass 120. At least a part of a left end, a right end, an upper end, and/or a lower end of the display 140 may be bent to form a curved surface and may be mounted in the housing 110. According to an embodiment, the display 140 may form an infinity display that occupies most of the front surface of the electronic device 100.

The display 140 may display various types of contents. The display 140 may include a polymer layer, a plurality of display elements coupled to one surface of the polymer layer, and at least one conductive line coupled with the polymer layer and electrically connected with the plurality of display elements. The polymer layer may be formed of a flexible material such that at least part of the polymer layer is capable of being curved toward a rear surface thereof. According to an embodiment, the polymer layer may contain polyimide. The plurality of display elements may be arranged in a matrix form on the one surface of the polymer layer to form pixels of the display 140 and may contain fluorescent materials, organic fluorescent materials, or the like that are capable of representing colors. According to an embodiment, the plurality of display elements may include organic light emitting diodes (OLEDs). The conductive line may include at least one gate signal line or at least one data signal line. According to an embodiment, a plurality of gate signal lines and a plurality of data signal lines may be arranged in a matrix form, and the plurality of display elements may be arranged adjacent to the intersections where the gate signal lines and the data signal lines cross each other and may be electrically connected with the intersections.

According to an embodiment, the display 140 may be connected with a display driver IC (DDI). The display driver IC may be electrically connected with the conductive line. The display driver IC may include a driver IC that provides driving signals and image signals to the display 140 or a timing controller (T-con) that controls the driving signals and the image signals. The driver IC may include a gate driver IC that sequentially selects the gate signal lines of the display 140 and applies scan signals (or driving signals) to the gate signal lines and a data driver IC (or a source driver IC) that applies image signals to the data signal lines of the display 120. According to an embodiment, when the gate driver IC selects the gate signal lines and applies scan signals to the gate signal lines to change the corresponding display elements into an activated state, the data driver IC may apply image signals to the corresponding display elements through the data signal lines. The timing controller may adjust transmission time of signals transmitted to the driver IC to prevent a difference in display time that is likely to occur in the process in which a screen is output on the display 140.

The back panel 150 may include, for example, at least one of an embo sheet and a heat dissipation sheet. The heat dissipation sheet may be formed of a thermally conductive material (e.g., copper, graphite, or the like). The heat dissipation sheet may prevent heat radiating from the display 140 from being transferred to the other internal components of the electronic device 100. According to an embodiment, an opening 151 may be formed in the back panel 150. For example, the opening 151 may be formed in an opaque area of the back panel 150 to allow light to be incident on the optical fingerprint sensor 171 disposed under the display 140. The opening 151 may be formed in a position aligned with a fingerprint sensing area 107 and the optical fingerprint sensor 171.

The bracket 160 may have the same size as, or a size similar to, that of the cover glass 120 and may fix and support the display 140. According to an embodiment, the bracket 160 may have a bonding material applied to at least a partial area thereof with which the display 140 is brought into contact, or may include a bonding layer on the at least a partial area of the bracket 160, such that the display 140 is fixed to the bracket 160. In some embodiments, the cover glass 120 may be fixed to the bracket 160 through a bonding member, a screw member, or the like.

The printed circuit board 170 may be disposed under the bracket 160, and various types of electronic parts may be mounted on the printed circuit board 170. For example, at least one electronic element, circuit line, or the like may be disposed on the printed circuit board 170, and at least some thereof may be electrically connected. The electronic parts may include, for example, a processor, a memory, a communication module, or the like. According to various embodiments, the display driver IC may be electrically connected with the printed circuit board 170, or may be disposed on the printed circuit board 170. Furthermore, the optical fingerprint sensor 171 may also be electrically connected with the printed circuit board 170. While FIG. 2 illustrates an example that the printed circuit board 170 is implemented with one body, the disclosure is not limited thereto. According to various embodiments, a plurality of printed circuit boards 170 may be provided, and at least some of the printed circuit boards 170 may be electrically connected together.

The battery 180 may supply power to the electronic device 100. For example, the battery 180 may be electrically connected with internal components of the electronic device 100 and may supply power to the internal components.

The back cover 190 may form the rear exterior of the electronic device 100. According to an embodiment, the back cover 190 may be attached to, or detached from, the housing 110. According to an embodiment, the back cover 190 may be fastened to the side surfaces of the housing 110 in the state of covering the rear surface of the housing 110.

Referring to FIG. 3, the components of the electronic device 100 may be mounted in the housing 110 in the state of being stacked one above another. For example, the back panel 150 and the display 140 may be sequentially stacked and mounted on the bracket 160 mounted in the housing 110, and the cover glass 120 may be fastened with the housing 110 in a form that covers the display 140. At this time, the intermediate layer 130 may be disposed between the cover glass 120 and the display 140. Furthermore, the printed circuit board 170 having various types of electronic parts mounted thereon and the battery 180 may be located under the bracket 160, and the back cover 190 may be fastened with the housing 110 in a form that covers the printed circuit board 170 and the battery 180. As illustrated in FIG. 3, the optical fingerprint sensor 171 may be located in the opening 151 formed in the back panel 150.

When light emitted from a light source (e.g., an LED or an OLED included in the display 140) is reflected from a user's fingerprint, the optical fingerprint sensor 171 may sense the reflected light and may obtain a fingerprint image. The optical fingerprint sensor 171 may include a filter layer 171a (e.g., a Red˜IR cut filter) that interrupts light in a specified wavelength band, an optical path layer 171b including the path of light transmitted through the filter layer 171a, and an image sensor 171c that receives the light transmitted through the optical path layer 171b. However, a configuration of the optical fingerprint sensor 171 is not limited thereto. In some embodiments, the optical fingerprint sensor 171 may not include the filter layer 171a.

According to an embodiment, the optical path layer 171b may determine a path along which light is incident on the image sensor 171c. According to an embodiment, the incident path of light may be determined such that the chief ray angle (CRA) of the incident light matches Brewster angle. In this case, the image sensor 171c may obtain a clearer fingerprint image because the light incident on the image sensor 171c does not include most of light reflected from the surface of the cover glass 120.

According to an embodiment, the image sensor 171c may include a plurality of pixels that receive the incident light. In this case, the image sensor 171c may obtain a fingerprint image using at least some of the optical signals received by the pixels. The pixels may receive light incident in different directions, respectively. For example, among the pixels, a first pixel may receive light incident in a first direction, and a second pixel may receive light incident in a second direction. In another example, among the pixels, a first pixel may receive light incident in a first direction, a second pixel may receive light incident in a second direction, a third pixel may receive light incident in a third direction, and a fourth pixel may receive light incident in a fourth direction.

According to an embodiment, the image sensor 171c may obtain one fingerprint image using a plurality of pixels that receive light incident in the same direction. For example, the image sensor 171c may obtain a first fingerprint image using a plurality of first pixels that receive light incident in the first direction, may obtain a second fingerprint image using a plurality of second pixels that receive light incident in the second direction, may obtain a third fingerprint image using a plurality of third pixels that receive light incident in the third direction, and may obtain a fourth fingerprint image using a plurality of fourth pixels that receive light incident in the fourth direction.

According to an embodiment, the optical fingerprint sensor 171 may be electrically connected with the processor mounted on the printed circuit board 170. Accordingly, the processor may receive a fingerprint image from the optical fingerprint sensor 171.

According to an embodiment, the processor may collect fingerprint information by analyzing the fingerprint image. For example, the processor may recognize a ridge-valley pattern of a fingerprint in the fingerprint image and may collect fingerprint information on the lengths and directions of ridges included in the fingerprint or minutia points (e.g., a point at which ridges are split, a point at which ridges are connected, or a point at which a ridge ends).

According to an embodiment, the processor may receive a plurality of fingerprint images (e.g., the first fingerprint image, the second fingerprint image, the third fingerprint image, or the fourth fingerprint image) from the image sensor 171c. In this case, the processor may generate one clearer fingerprint image by a combination of the plurality of fingerprint images. Alternatively, the processor may generate one three-dimensional (3D) fingerprint image by a combination of the plurality of fingerprint images.

According to an embodiment, the processor may store, in the memory, at least one of the received fingerprint image, the generated fingerprint image, and the fingerprint information collected by analyzing the fingerprint image.

According to an embodiment, the processor may determine whether the user is authenticated, by comparing the received fingerprint image, the generated fingerprint image, or the fingerprint information collected by analyzing the fingerprint image with fingerprint-related information stored in the memory.

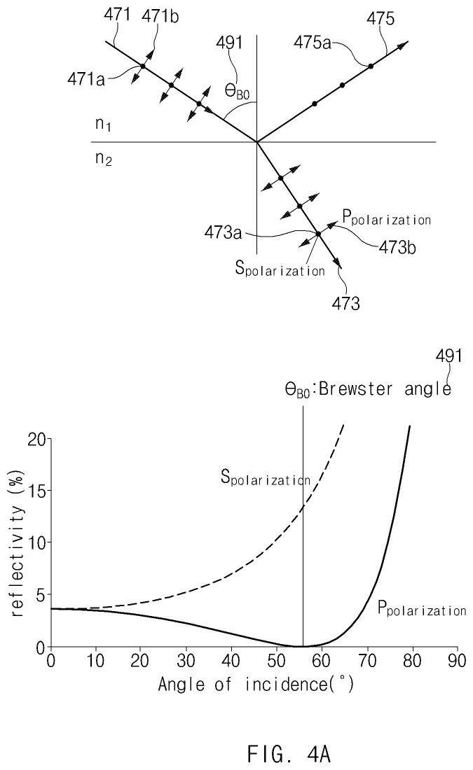

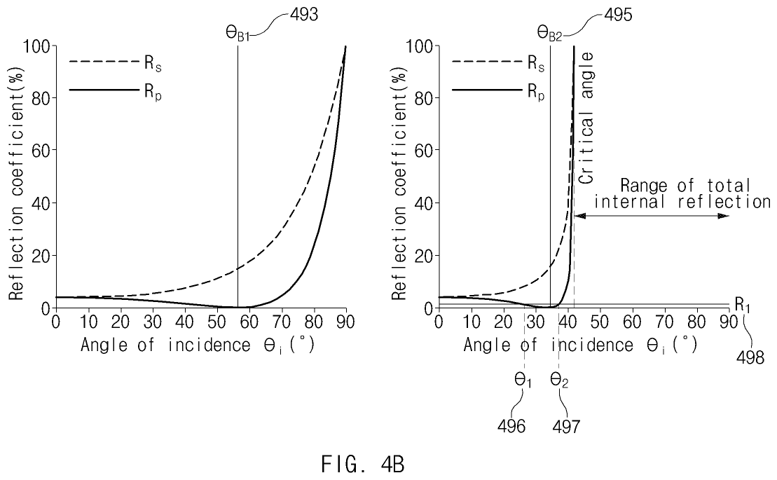

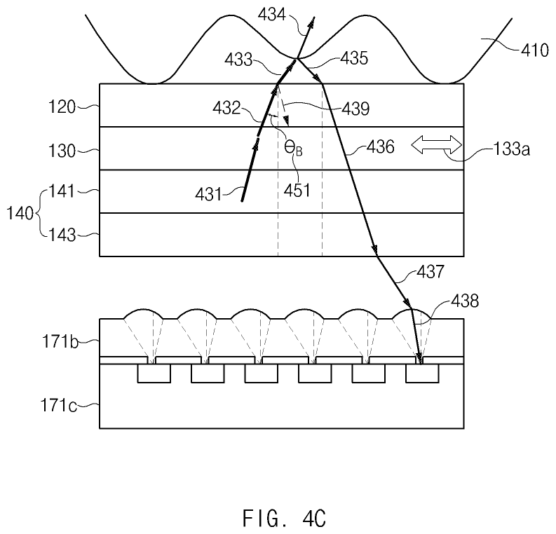

FIG. 4A is a view illustrating Brewster angle according to an embodiment of the disclosure.

Referring to FIG. 4A, when light 471 is input from a first medium with a first refractive index n₁ to a second medium with a second refractive index n₂, reflected light 475 may be polarized in a direction perpendicular to the plane of incidence if the angle of incidence is Brewster angle θ_{BO} 491. For example, even though the light 471 incident at Brewster angle 491 determined by characteristics of the first medium and the second medium includes a component (e.g., an S-wave component) 471a perpendicular to the plane of incidence and a component (e.g., a P-wave component) 471b parallel to the plane of incidence, the light 475 reflected from the interface between the first medium and the second medium may include only a component 475a perpendicular to the plane of incidence. That is, the component 471b parallel to the plane of incidence may be refracted and transmitted without being reflected. As in the upper drawing illustrated in FIG. 4A, the reflected light 475 may include only the component 475a perpendicular to the plane of incidence, and light 473 refracted at the interface and transmitted through the interface may include both a component 473a perpendicular to the plane of incidence and a component 473b parallel to the plane of incidence.

The lower drawing illustrated in FIG. 4A is a graph depicting reflectivity versus angle of incidence. From the graph, it can be seen that the reflectivity for a parallel component P_{polarization} of light is 0% when the angle of incidence of the light is Brewster angle 491.

FIG. 4B is a view illustrating Brewster angle depending on characteristics of mediums according to an embodiment of the disclosure.

Referring to FIG. 4B, Brewster angle may be differently determined depending on the characteristics of the mediums. For example, the angle at which the reflectivity for a component (e.g., a P-wave component) of light that is parallel to the plane of incidence closely approaches 0% may vary depending on the characteristics of the mediums. The left drawing of FIG. 4B is a graph depicting reflectivity versus angle of incidence when light is input from a first medium (e.g., air) with a first refractive index to a second medium (e.g., glass) with a second refractive index, and the right drawing of FIG. 4B is a graph depicting reflectivity versus angle of incidence when light is input from the second medium to the first medium. It can be seen that as in the left drawing of FIG. 4B, Brewster angle 493 is determined to be about 56 degrees when the light is input from the first medium to the second medium, and it can be seen that as in the right drawing of FIG. 4B, Brewster angle 495 is determined to be about 36 degrees when the light is input from the second medium to the first medium.

According to an embodiment, the incident path of light that is determined by the optical path layer 171b described above with reference to FIGS. 1 to 3 may be obliquely formed to be inclined at Brewster angle with respect to the optical axis of the image sensor 171c such that most of light reflected from the surface of the cover glass 120 is not transmitted. In another embodiment, the incident path of light may be formed to be inclined with respect to the optical axis of the image sensor 171c to correspond to the incidence angle range of θ₁ 496 to θ₂ 497 in which the reflectivity for a parallel component of light reflected from the surface of the cover glass 120 has a specified magnitude R₁ 498 or less. For example, as in the right drawing of FIG. 4B, the incident path of light may be formed in the range of about 26% to about 37% with respect to the optical axis of the image sensor 171c to correspond to the incidence angle range in which the reflectivity for a parallel component of light reflected from the surface of the cover glass 120 is equal to 1% or less.

FIG. 4C is a view illustrating reflection of light from the cover glass according to an embodiment of the disclosure.

Referring to FIG. 4C, a display element 141 (e.g., an organic light emitting diode) that is disposed on a substrate 143 of the display 140 may be used as a light source for the optical fingerprint sensor 171.

According to an embodiment, a component (e.g., a P-wave component) that oscillates in the same direction as the polarization direction 133a of the polarizer 133, among the light emitted 431 from the display element 141, may be transmitted 432 through the polarizer 133, but a component (e.g., an S-wave component) that oscillates in a different direction may not be transmitted 432 through the polarizer 133.

According to an embodiment, part of the light transmitted 432 through the polarizer 133 may be refracted 433 and may directly reach a fingerprint 410 or may reach the fingerprint 410 through an air layer. Part of the light that reaches the fingerprint 140 may be absorbed 434 into the fingerprint 410, and another part may be reflected 435 from the surface of the fingerprint 410. In this case, the light reflected 435 from the surface of the fingerprint 410 may be transmitted 436 through the cover glass 120 and the polarizer 133 again and may be refracted 437 at the surface of the substrate 143 of the display 140 that meets an air layer. The refracted light may be refracted 438 at the surface of the lens 171b again and may reach the image sensor 171c.

According to an embodiment, another part of the light transmitted 432 through the polarizer 133 may be reflected 439 from the surface of the cover glass 120, and in the case where the angle of incidence is equal to Brewster angle θ_{B} 451, a component (e.g., a P-wave component) that is parallel to the plane of incidence, among the light specularly reflected 439 from the surface of the cover glass 120, may not be reflected. In other words, a component parallel to the polarization direction 133a of the polarizer 133 may not be present in the light reflected 439 from the cover glass 120 at Brewster angle 451. According to an embodiment, reflected light that is reflected from the cover glass 120 at Brewster angle 451 and reaches the optical path layer 171b may not be present because the component (e.g., a P-wave component) that is parallel to the plane of incidence, among the light incident 432 at Brewster angle 451, is refracted 433 at the surface of the cover glass 120 and transmitted through the cover glass 120 without being reflected 439 and the component (e.g., an S-wave component) that is perpendicular to the plane of incidence fails to pass through the polarizer 133. Furthermore, because the incident path of light determined by the optical path layer 171b is obliquely formed to be inclined at a specified angle (e.g., Brewster angle 451) with respect to the optical axis (or the central axis) of the image sensor 171c, light incident on the cover glass 120 at an angle different from Brewster angle 451 may not pass through the incident path of light included in the optical path layer 171b even though the light is reflected from the surface of the cover glass 120 and reaches the optical path layer 171b. Accordingly, a clear fingerprint image that is not affected by light reflected from the cover glass 120 may be obtained by using only light reflected from the fingerprint 410.

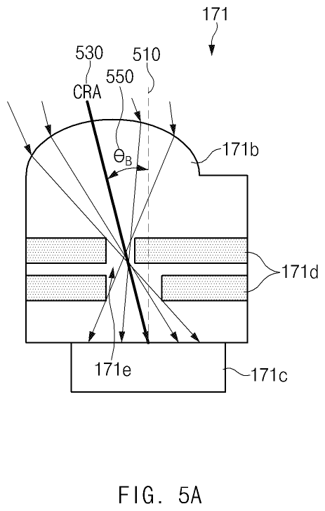

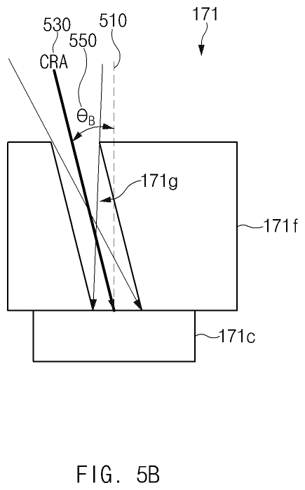

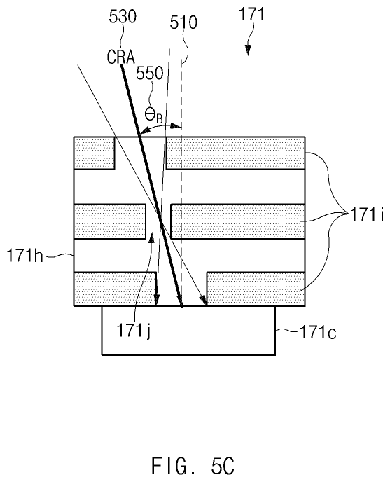

FIG. 5A is a sectional view of the optical fingerprint sensor adjusting an incident path of light using a micro lens according to an embodiment of the disclosure, FIG. 5B is a sectional view of the optical fingerprint sensor adjusting an incident path of light using a pin hole according to an embodiment of the disclosure, and FIG. 5C is a sectional view of the optical fingerprint sensor adjusting an incident path of light using a masked pin hole according to an embodiment of the disclosure.

Referring to FIGS. 5A to 5C, the optical fingerprint sensor 171 may be designed such that the path of light incident on the image sensor 171c corresponds to Brewster angle θ_{B} 550. The incident path of light may be determined such that the chief ray angle (CRA) 530 of the incident light matches Brewster angle 550.

According to an embodiment, as illustrated in FIG. 5A, the optical fingerprint sensor 171 may be designed such that an incident path of light corresponds to Brewster angle 550 by applying a masking pattern 171d to the micro lens 171b eccentrically located by a specified magnitude on the image sensor 171c relative to the central axis 510 of the image sensor 171c. In this case, the light may be incident through a space 171e in which the masking pattern 171d is not located. That is, the space 171e may be the incident path of light.

According to an embodiment, as illustrated in FIG. 5B, the optical fingerprint sensor 171 may be designed such that the direction of a pin hole 171g formed in an opaque member 171f located on the image sensor 171c corresponds to Brewster angle 550. In this case, light may be incident through the pin hole 171g. That is, the pin hole 171g may be the incident path of light.

According to an embodiment, as illustrated in FIG. 5C, the optical fingerprint sensor 171 may be designed such that an incident path of light corresponds to Brewster angle 550 by applying a masking pattern 171i to a transparent member 171h located on the image sensor 171c. In this case, a space 171j in which the masking pattern 171i is not located may serve as a pin hole. That is, the space 171j may be the incident path of light.

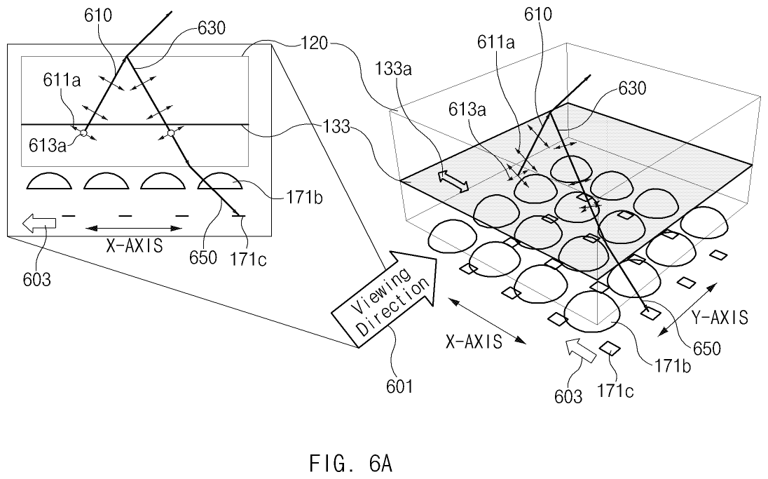

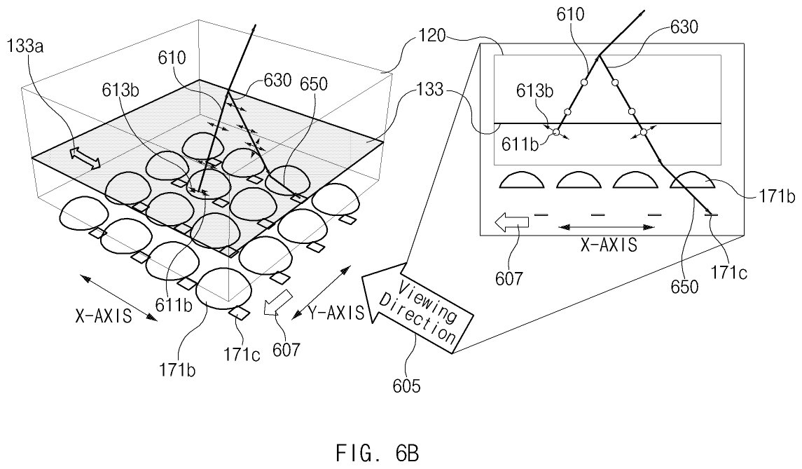

FIG. 6A is a view illustrating the amount of incident light in a case of having a plane of incidence of light parallel to a polarization direction according to an embodiment of the disclosure, and FIG. 6B is a view illustrating the amount of incident light in a case of having a plane of incidence of light perpendicular to a polarization direction according to an embodiment of the disclosure.

Referring to FIGS. 6A and 6B, light 610 emitted from a light source (e.g., the display element 141) may have a component 611a or 611b (e.g., a P-wave component) that is parallel to the polarization direction 133a of the polarizer 133 and a component 613a or 613b (e.g., an S-wave component) that is perpendicular to the polarization direction 133a. Only the component 611a or 611b of the light 610 that is parallel to the polarization direction 133a may be transmitted through the polarizer 133.

According to an embodiment, the light 610 transmitted through the polarizer 133 may be reflected from the surface of the cover glass 120. Light 630 reflected from the surface of the cover glass 120 may have only the component 611a or 611b parallel to the polarization direction 133a. In the case where the reflected light 630 is reflected to correspond to Brewster angle, as illustrated in FIG. 6A, only the component 613a perpendicular to a plane of incidence (a plane that includes the travel path of the light 610 incident on the cover glass 120 and the travel path of the light 630 reflected from the cover glass 120 and that is perpendicular to the interface (or the surface) of the cover glass 120) may be reflected, and therefore the amount of the light 630 reflected from the surface of the cover glass 120 may be decreased when the plane of incidence is parallel to the polarization direction 133a.

According to an embodiment, the reflected light 630 may be incident on the image sensor 171c through the lens 171b, and the path of light 650 incident on the image sensor 171c, as illustrated in FIG. 6A, may be implemented through the lens 171b eccentrically located by a specified magnitude relative to the central axis of the image sensor 171c in a first direction 603 (e.g., the direction (the x-axis direction) that is parallel to the polarization direction 133a of the polarizer 133).

According to an embodiment, as illustrated in FIG. 6A, the amount of the light 630 reflected from the surface of the cover glass 120 may be decreased in the case where the plane of incidence is parallel to the polarization direction 133a and the incident path corresponds to Brewster angle. For example, because the light 630 reflected from the surface of the cover glass 120 includes only the component 611a parallel to the plane of incidence, the amount of light reflected from the surface of the cover glass 120 may be decreased. Furthermore, because the perpendicular component 613a of the reflected light 630 fails to pass through the polarizer 133, the reflected light 630 may not be included in the light 650 incident on the image sensor 171c. In other words, only the component 611a parallel to the polarization direction 133a among the light emitted from the display element 141 may pass through the polarizer 133, and therefore the reflected light 630 may have only the parallel component. Furthermore, there may be no light reflected from the surface of the cover glass 120 and incident on the image sensor 171c because the reflectivity of the parallel component at the surface of the cover glass 120 is 0% as illustrated in FIG. 4B when light is incident at Brewster angle.

According to an embodiment, as illustrated in FIG. 6B, only the component 611b perpendicular to the plane of incidence may be reflected in the case where the plane of incidence is perpendicular to the polarization direction 133a and the reflected light 630 is reflected to correspond to Brewster angle. However, the perpendicular component 611b of the reflected light 630 may pass through the polarizer 133 because the perpendicular component 611b oscillates parallel to the polarization direction 133a. Accordingly, in the case where the plane of incidence is perpendicular to the polarization direction 133a, the amount by which the light 630 reflected from the surface of the cover glass 120 passes through the polarizer 133 may be relatively increased, compared to that described above with reference to FIG. 6A.

According to an embodiment, the reflected light 630 may be incident on the image sensor 171c through the lens 171b, and the path of the light 650 incident on the image sensor 171c, as illustrated in FIG. 6B, may be implemented through the lens 171b eccentrically located by a specified magnitude relative to the central axis of the image sensor 171c in a second direction 607 (e.g., the direction (the y-axis direction) that is perpendicular to the polarization direction 133a of the polarizer 133).

According to an embodiment, as illustrated in FIG. 6b, in the case where the plane of incidence is perpendicular to the polarization direction 133a and the incident path corresponds to Brewster angle, the light 630 reflected from the surface of the cover glass 120 may include only the component 613b perpendicular to the plane of incidence, and the perpendicular component 613b of the reflected light 630 may pass through the polarizer 133. Consequently, the amount of the light 650 incident on the image sensor 171c may be relatively increased, compared to that described above with reference to FIG. 6A. In other words, when the direction 605 (e.g., the x-axis direction) that is parallel to the polarization direction 133a is perpendicular to the plane of incidence, the amount of the light 650 reflected from the surface of the cover glass 120 and incident on the image sensor 171c may be relatively increased, compared to that described above with reference to FIG. 6A.

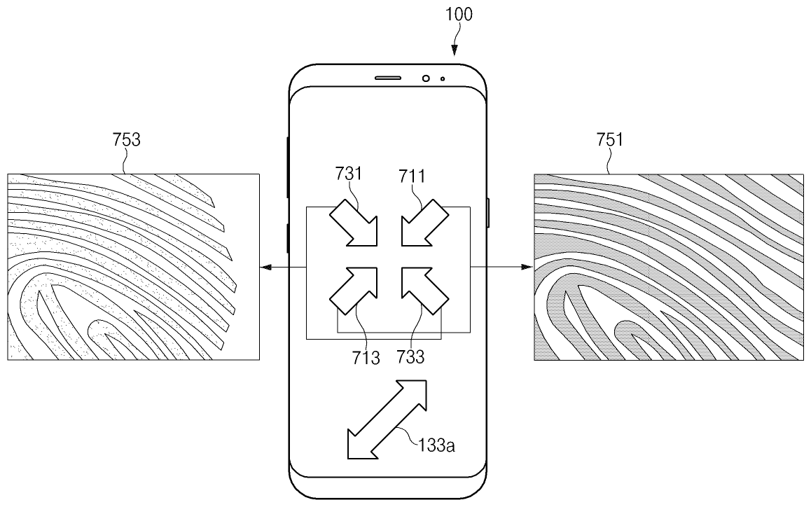

FIG. 7 is a view illustrating a method of obtaining a fingerprint image using an optical fingerprint sensor having an incident path of light parallel to a polarization direction and an optical fingerprint sensor having an incident path of light perpendicular to the polarization direction according to an embodiment of the disclosure.

Referring to FIG. 7, the electronic device 100 may include at least one first optical fingerprint sensor having an incident path of light in directions 711 and 713 parallel to the polarization direction 133a of the polarizer 133 and at least one second optical fingerprint sensor having an incident path of light in directions 731 and 733 perpendicular to the polarization direction 133a of the polarizer 133.

According to an embodiment, a first fingerprint image 751 obtained through the first optical fingerprint sensor may be an image in which the amount of light reflected from the cover glass 120 is decreased as described above with reference to FIG. 6A. In another example, a second fingerprint image 753 obtained through the second optical fingerprint sensor may be an image in which the amount of light reflected from the cover glass 120 is increased as described above with reference to FIG. 6B.

According to an embodiment, the first fingerprint image 751 in which the amount of light reflected from the cover glass 120 is decreased may facilitate identification of a fingerprint in the state in which a finger is not completely in contact with the cover glass 120. In another example, the second fingerprint image 753 in which the amount of light reflected from the cover glass 120 is increased may facilitate identification of a fingerprint in the state in which a finger is completely in contact with the cover glass 120.

According to an embodiment, the electronic device 100 may improve the performance of fingerprint recognition by identifying a fingerprint through a combination of the first fingerprint image 751 and the second fingerprint image 753.

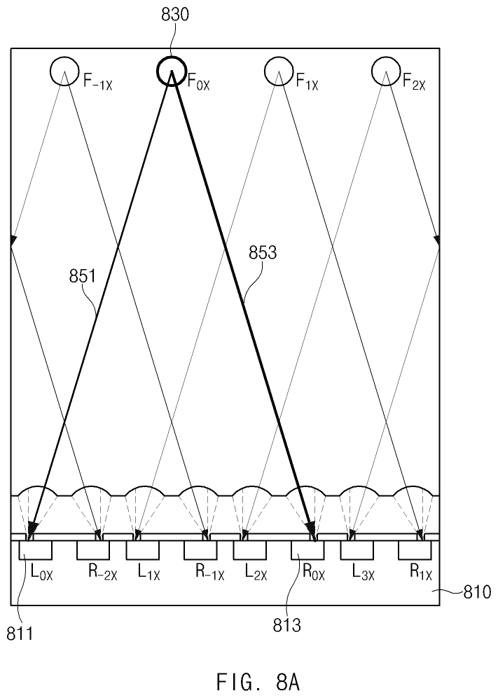

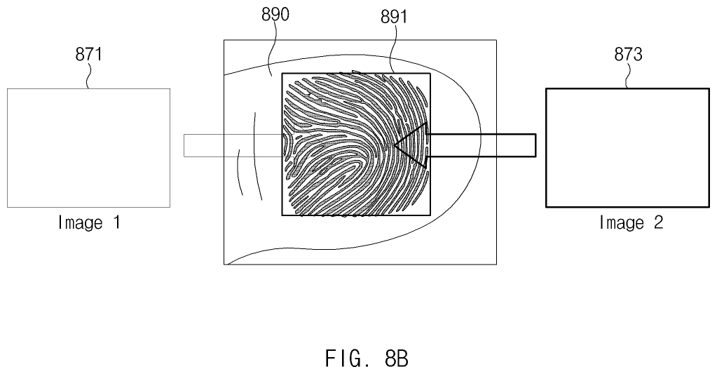

FIG. 8A is a view illustrating optical fingerprint sensors having incident paths of light in different directions according to an embodiment of the disclosure, and FIG. 8B is a view illustrating a method of obtaining a fingerprint image using the optical fingerprint sensors having the incident paths of light in the different directions according to an embodiment of the disclosure.

Referring to FIGS. 8A and 8b, an image sensor 810 (e.g., the image sensor 171c) may include a plurality of pixels L_{0X}, R_{-2X}, L_{1X}, R_{-1X}, L_{2X}, R_{0X}, L_{3X}, R_{1X}, or the like that receive light. Each of the pixels may receive light reflected from any one point (e.g., F₋₁ₓ, F₀ₓ, F₁ₓ, F₂ₓ, or the like) of a fingerprint 890.

According to an embodiment, an electronic device (e.g., the electronic device 100) may obtain a plurality of fingerprint images through the plurality of pixels that receive light reflected from the same point of the fingerprint 890 in different directions. For example, the electronic device may obtain a first fingerprint image 871 through a first pixel 811 (e.g., L_{0X}) that receives light reflected from a first point 830 (e.g., F_{0X}) of the fingerprint 890 in a first direction 851 and may obtain a second fingerprint image 873 through a second pixel 813 (e.g., R_{0X}) that receives light reflected from the first point 830 in a second direction 853. In other words, the first fingerprint image 871 and the second fingerprint image 873 may be images when the first point 830 of the fingerprint 890 is viewed in different directions.

According to an embodiment, the electronic device may generate a three-dimensional image for the first point 830 of the fingerprint 890 by a combination of the first fingerprint image 871 and the second fingerprint image 873.

According to an embodiment, the image sensor 810 may include a plurality of first pixels 811 that receive light incident in the first direction 851 and a plurality of second pixels 813 that receive light incident in the second direction 853. For example, the first pixels 811 may be disposed at specified intervals and may receive light incident from different points of the fingerprint 890 in the same first direction 851, and the second pixels 813 may be disposed at specified intervals and may receive light incident from the different points of the fingerprint 890 in the same second direction 853. In this case, the electronic device may obtain the first fingerprint image 871 for at least a partial area of the fingerprint 890 through the first pixels 811 and may obtain the second fingerprint image 873 for the area through the second pixels 813. Accordingly, the electronic device may generate a three-dimensional fingerprint image 891 for the area by a combination of the first fingerprint image 871 and the second fingerprint image 873.

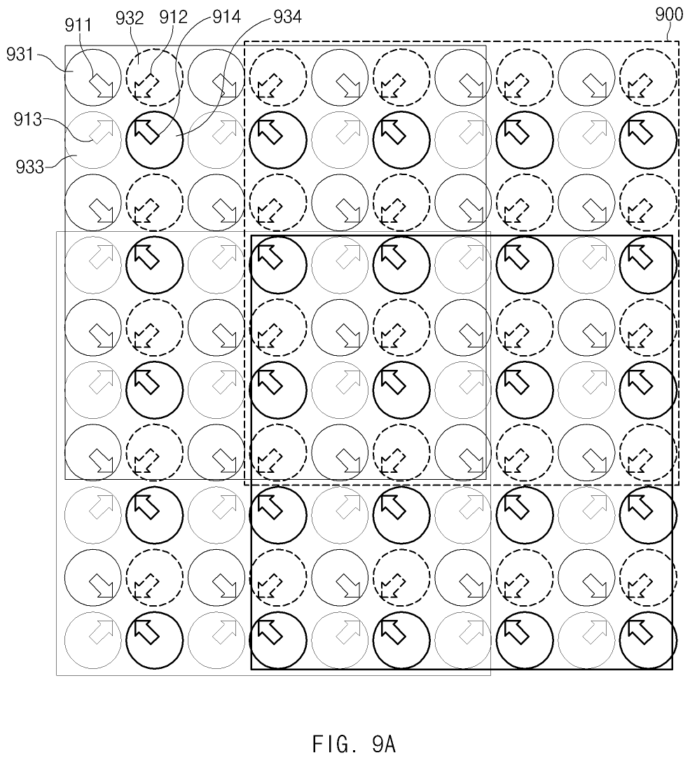

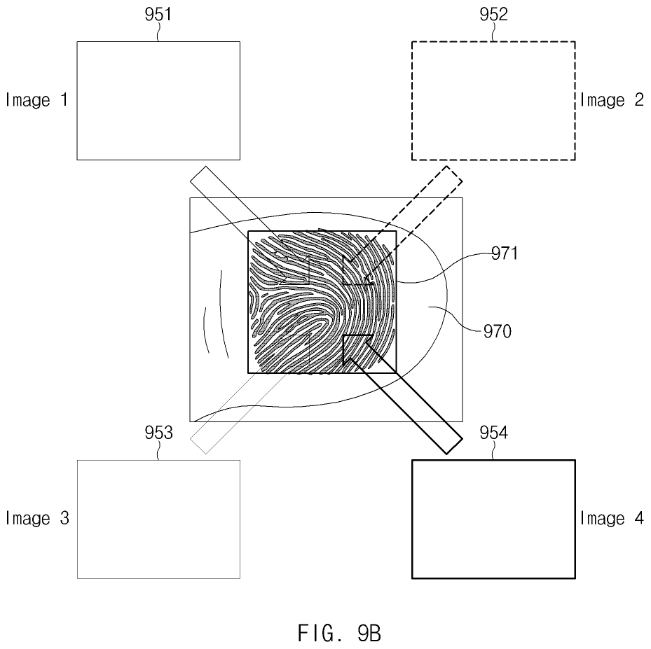

FIG. 9A is a view illustrating optical fingerprint sensors having incident paths of light in different directions according to an embodiment of the disclosure, and FIG. 9B is a view illustrating a method of obtaining a fingerprint image using the optical fingerprint sensors having the incident paths of light in the different directions according to an embodiment of the disclosure.

Referring to FIGS. 9A and 9B, an image sensor 900 (e.g., the image sensor 171c) may include a plurality of pixels (e.g., a first pixel 931, a second pixel 932, a third pixel 933, a fourth pixel 934, or the like) that receive light.

According to an embodiment, the image sensor 900 may include a plurality of first pixels 931 that receive light incident in a first direction 911, a plurality of second pixels 932 that receive light incident in a second direction 912, a plurality of third pixels 933 that receive light incident in a third direction 913, and a plurality of fourth pixels 934 that receive light incident in a fourth direction 914. For example, the first pixels 931 may be disposed at specified intervals and may receive light incident from different points of a fingerprint 970 in the same first direction 911, the second pixels 932 may be disposed at specified intervals and may receive light incident from the different points of the fingerprint 970 in the same second direction 912, the third pixels 933 may be disposed at specified intervals and may receive light incident from the different points of the fingerprint 970 in the same third direction 913, and the fourth pixels 934 may be disposed at specified intervals and may receive light incident from the different points of the fingerprint 970 in the same fourth direction 914.

According to an embodiment, as illustrated in FIG. 9A, the first direction 911 and the fourth direction 914 may be parallel to each other, and the second direction 912 and the third direction 913 may be parallel to each other. Furthermore, the first direction 911 and the second direction 912 (or the third direction 913) may be perpendicular to each other, and likewise, the fourth direction 914 may also be perpendicular to the second direction 912 (or the third direction 913).

According to an embodiment, the electronic device may obtain a first fingerprint image 951 for at least a partial area of the fingerprint 970 through the first pixels 931, may obtain a second fingerprint image 952 for the area through the second pixels 932, may obtain a third fingerprint image 953 for the area through the third pixels 933, and may obtain a fourth fingerprint image 954 for the area through the fourth pixels 934. Accordingly, the electronic device may generate a three-dimensional fingerprint image 971 for the area by a combination of the first fingerprint image 951, the second fingerprint image 952, the third fingerprint image 953, and the fourth fingerprint image 954.

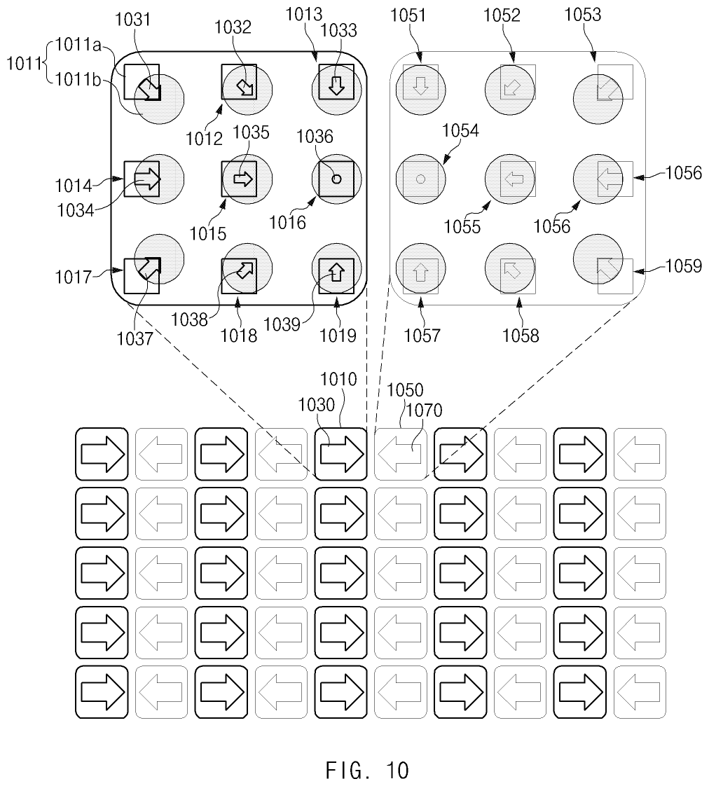

FIG. 10 is a view illustrating a pixel of an optical fingerprint sensor including a plurality of sub-pixels according to an embodiment of the disclosure.

Referring to FIG. 10, each of pixels of an image sensor (e.g., the image sensor 171c) may include sub-pixels. For example, a first pixel 1010 of the image sensor may include a first sub-pixel 1011, a second sub-pixel 1012, a third sub-pixel 1013, a fourth sub-pixel 1014, a fifth sub-pixel 1015, a sixth sub-pixel 1016, a seventh sub-pixel 1017, an eighth sub-pixel 1018, and a ninth sub-pixel 1019. In another example, a second pixel 1050 of the image sensor may include a tenth sub-pixel 1051, an eleventh sub-pixel 1052, a twelfth sub-pixel 1053, a thirteenth sub-pixel 1054, a fourteenth sub-pixel 1055, a fifteenth sub-pixel 1056, a sixteenth sub-pixel 1057, a seventeenth sub-pixel 1058, and an eighteenth sub-pixel 1059.

According to an embodiment, a plurality of sub-pixels included in any one pixel may be disposed at specified intervals. For example, the sub-pixels may be disposed in a grid shape.

According to an embodiment, the electronic device may obtain a first fingerprint image for at least a partial area of a fingerprint through a plurality of first pixels 1010 and may obtain a second fingerprint image for the area through a plurality of second pixels 1050. The first fingerprint image may be an image when the fingerprint is viewed in a first direction 1030, and the second fingerprint image may be an image when the fingerprint is viewed in a second direction 1070.

According to an embodiment, a plurality of sub-pixels included in any one pixel may receive light incident in different directions. For example, the first sub-pixel 1011 may receive light incident in a first direction 1031 of a first vector with the center of a light receiving element 1011a and the center of a lens 1011b as a starting point and an ending point. The second sub-pixel 1012 may receive light incident in a second direction 1032 of a second vector with the center of a light receiving element included in the second sub-pixel 1012 and the center of a lens as a starting point and an ending point. The third sub-pixel 1013 may receive light incident in a third direction 1033 of a third vector with the center of a light receiving element included in the third sub-pixel 1013 and the center of a lens as a starting point and an ending point. The fourth sub-pixel 1014 may receive light incident in a fourth direction 1034 of a fourth vector with the center of a light receiving element included in the fourth sub-pixel 1014 and the center of a lens as a starting point and an ending point. The fifth sub-pixel 1015 may receive light incident in a fifth direction 1035 of a fifth vector with the center of a light receiving element included in the fifth sub-pixel 1015 and the center of a lens as a starting point and an ending point. The sixth sub-pixel 1016 may receive light incident in a sixth direction 1036 of a sixth vector with the center of a light receiving element included in the sixth sub-pixel 1016 and the center of a lens as a starting point and an ending point. The seventh sub-pixel 1017 may receive light incident in a seventh direction 1037 of a seventh vector with the center of a light receiving element included in the seventh sub-pixel 1017 and the center of a lens as a starting point and an ending point. The eighth sub-pixel 1012 may receive light incident in an eighth direction 1038 of an eighth vector with the center of a light receiving element included in the eighth sub-pixel 1018 and the center of a lens as a starting point and an ending point. The ninth sub-pixel 1019 may receive light incident in a ninth direction 1039 of a ninth vector with the center of a light receiving element included in the ninth sub-pixel 1019 and the center of a lens as a starting point and an ending point.

According to an embodiment, assuming that each of a plurality of sub-pixels included in any one pixel corresponds to a vector with the center of a light receiving element included in the sub-pixel and the center of a lens as a starting point and an ending point, the direction of the sum of the vectors corresponding to the sub-pixels may correspond to the direction in which the pixel faces the fingerprint. For example, the direction of the vector obtained by adding the first vector, the second vector, the third vector, the fourth vector, the fifth vector, the sixth vector, the seventh vector, the eighth vector, and the ninth vector together may correspond to the direction 1030 in which the first pixel faces the fingerprint.

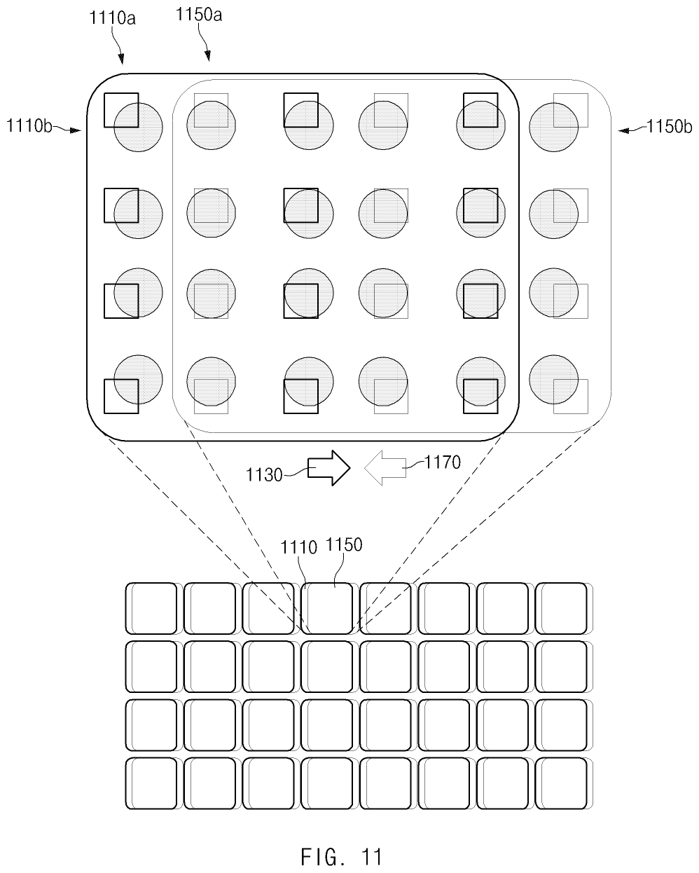

FIG. 11 is a view illustrating a pixel of an optical fingerprint sensor including a plurality of sub-pixels according to an embodiment of the disclosure.

Referring to FIG. 11, a first pixel 1110 that appears to face a fingerprint in a first direction 1130 and a second pixel 1150 that appears to face the fingerprint in a second direction 1170 may be paired with each other. Furthermore, each of the first pixel 1110 and the second pixel 1150 may include a plurality of sub-pixels.

According to an embodiment, the first pixel 1110 and the second pixel 1150 paired with each other may cross each other from the point of view of a pixel. In this case, the sub-pixels included in each pixel may not be adjacent to each other. For example, as illustrated in FIG. 11, when the first pixel 1110 and the second pixel 1150 cross each other, first sub-pixels of the first pixel 1110 and second sub-pixels of the second pixel 1150 may be disposed to alternate with each other, and therefore the first sub-pixels or the second sub-pixels may not be adjacent to each other.

FIG. 11 illustrates a state in which the first pixel 1110 and the second pixel 1150 cross each other in the left/right direction and the first sub-pixels and the second sub-pixels are alternately disposed in rows. For example, each row 1110a of the first sub-pixels may be located between rows 1150a of the second sub-pixels. However, an arrangement of the sub-pixels is not limited thereto. In some embodiments, the first pixel 1110 and the second pixel 1150 may cross each other in the vertical direction, and the first sub-pixels and the second sub-pixels may be alternately disposed in columns. For example, each column 1110b of the first sub-pixels may be located between columns 1150b of the second sub-pixels.

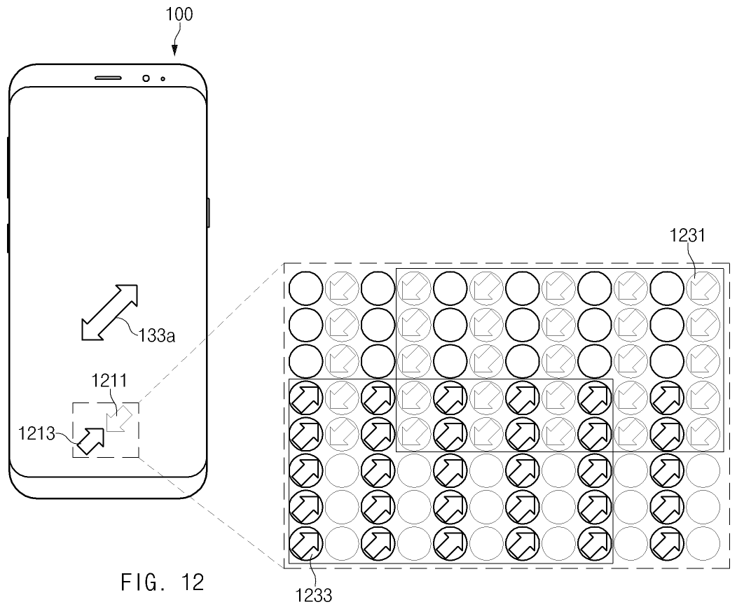

FIG. 12 is a view illustrating optical fingerprint sensors having incident paths of light in different directions parallel to a polarization direction according to an embodiment of the disclosure.

Referring to FIG. 12, the optical fingerprint sensor 171 included in the electronic device 100 may include an incident path (or a passage) of light that is parallel to the polarization direction 133a of the polarizer 133. For example, to prevent light reflected from the cover glass 120 from reaching the image sensor 171c, the optical fingerprint sensor 171 may be designed such that the incident path (or the passage) of light is parallel to the polarization direction 133a. Accordingly, the electronic device 100 may obtain a clearer fingerprint image.

According to an embodiment, the image sensor 171c may include a plurality of pixels (e.g., a first pixel 1231, a second pixel 1233, and the like). The direction in which a lens is eccentrically located relative to the center of a light receiving element included in each of the plurality of pixels may be parallel to the polarization direction 133a of the polarizer 133. For example, a first direction 1211 in which a lens is eccentrically located relative to the center of a light receiving element included in the first pixel 1231 and a second direction 1213 in which a lens is eccentrically located relative to the center of a light receiving element included in the second pixel 1233 may be parallel to the polarization direction 133a.

According to an embodiment, the image sensor 171 may include a plurality of first pixels 1231 that receive light incident in the first direction 1211 and a plurality of second pixels 1233 that receive light incident in the second direction 1213. For example, the first pixels 1231 may be disposed at specified intervals and may receive light incident from different points of a fingerprint in the same first direction 1211, and the second pixels 1233 may be disposed at specified intervals and may receive light incident from the different points of the fingerprint in the same second direction 1213. In this case, the electronic device 100 may obtain a first fingerprint image for at least a partial area of the fingerprint through the first pixels 1231 and may obtain a second fingerprint image for the area through the second pixels 1233. Accordingly, the electronic device may generate a three-dimensional fingerprint image for the area by a combination of the first fingerprint image and the second fingerprint image. Consequently, the electronic device 100 may obtain a clearer three-dimensional fingerprint image using the image sensor 171c including the pixels that receive light incident in the first direction 1211 and the second direction 1213 that are different from each other and are parallel to the polarization direction 133a.

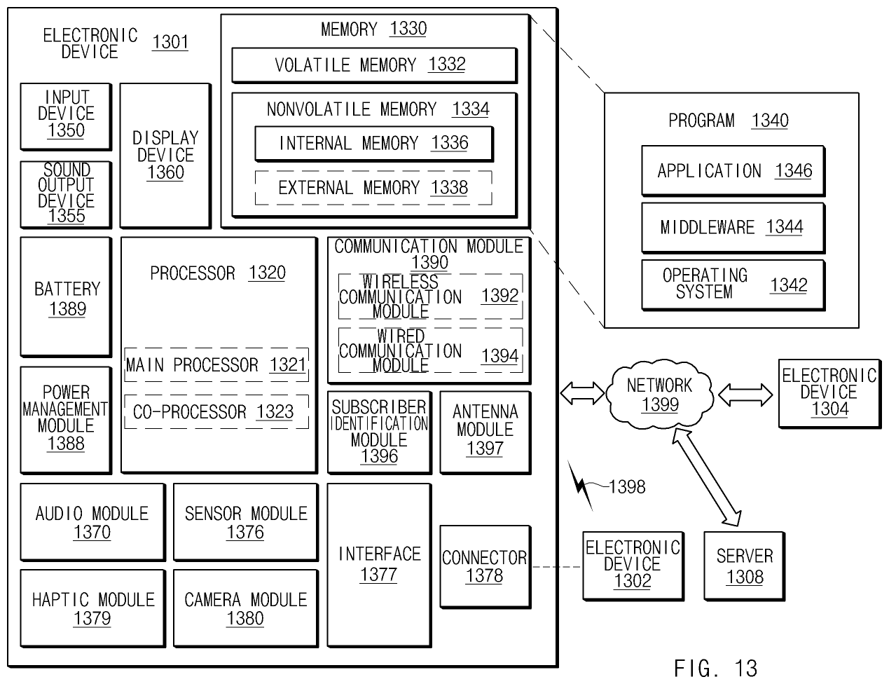

FIG. 13 is a block diagram illustrating an electronic device 1301 in a network environment 1300 according to various embodiments. Referring to FIG. 13, the electronic device 1301 in the network environment 1300 may communicate with an electronic device 1302 via a first network 1398 (e.g., a short-range wireless communication network), or an electronic device 1304 or a server 1308 via a second network 1399 (e.g., a long-range wireless communication network). According to an embodiment, the electronic device 1301 may communicate with the electronic device 1304 via the server 1308. According to an embodiment, the electronic device 1301 may include a processor 1320, memory 1330, an input device 1350, a sound output device 1355, a display device 1360, an audio module 1370, a sensor module 1376, an interface 1377, a haptic module 1379, a camera module 1380, a power management module 1388, a battery 1389, a communication module 1390, a subscriber identification module (SIM) 1396, or an antenna module 1397. In some embodiments, at least one (e.g., the display device 1360 or the camera module 1380) of the components may be omitted from the electronic device 1301, or one or more other components may be added in the electronic device 1301. In some embodiments, some of the components may be implemented as single integrated circuitry. For example, the sensor module 1376 (e.g., a fingerprint sensor, an iris sensor, or an illuminance sensor) may be implemented as embedded in the display device 1360 (e.g., a display).

The processor 1320may execute, for example, software (e.g., a program 1340) to control at least one other component (e.g., a hardware or software component) of the electronic device 1301 coupled with the processor 1320, and may perform various data processing or computation. According to one embodiment, as at least part of the data processing or computation, the processor 1320 may load a command or data received from another component (e.g., the sensor module 1376 or the communication module 1390) in volatile memory 1332, process the command or the data stored in the volatile memory 1332, and store resulting data in non-volatile memory 1334. According to an embodiment, the processor 1320 may include a main processor 1321 (e.g., a central processing unit (CPU) or an application processor (AP)), and an auxiliary processor 1323 (e.g., a graphics processing unit (GPU), an image signal processor (ISP), a sensor hub processor, or a communication processor (CP)) that is operable independently from, or in conjunction with, the main processor 1321. Additionally or alternatively, the auxiliary processor 1323 may be adapted to consume less power than the main processor 1321, or to be specific to a specified function. The auxiliary processor 1323 may be implemented as separate from, or as part of the main processor 1321.

The auxiliary processor 1323 may control at least some of functions or states related to at least one component (e.g., the display device 1360, the sensor module 1376, or the communication module 1390) among the components of the electronic device 1301, instead of the main processor 1321 while the main processor 1321 is in an inactive (e.g., sleep) state, or together with the main processor 1321 while the main processor 1321 is in an active state (e.g., executing an application). According to an embodiment, the auxiliary processor 1323 (e.g., an image signal processor or a communication processor) may be implemented as part of another component (e.g., the camera module 1380 or the communication module 1390) functionally related to the auxiliary processor 1323.

The memory 1330 may store various data used by at least one component (e.g., the processor 1320 or the sensor module 1376) of the electronic device 1301. The various data may include, for example, software (e.g., the program 1340) and input data or output data for a command related thererto. The memory 1330 may include the volatile memory 1332 or the non-volatile memory 1334.

The program 1340may be stored in the memory 1330 as software, and may include, for example, an operating system (OS) 1342, middleware 1344, or an application 1346.

The input device 1350 may receive a command or data to be used by other component (e.g., the processor 1320) of the electronic device 1301, from the outside (e.g., a user) of the electronic device 1301. The input device 1350 may include, for example, a microphone, a mouse, a keyboard, or a digital pen (e.g., a stylus pen).

The sound output device 1355 may output sound signals to the outside of the electronic device 1301. The sound output device 1355 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 1360 may visually provide information to the outside (e.g., a user) of the electronic device 1301. The display device 1360 may include, for example, a display, a hologram device, or a projector and control circuitry to control a corresponding one of the display, hologram device, and projector. According to an embodiment, the display device 1360 may include touch circuitry adapted to detect a touch, or sensor circuitry (e.g., a pressure sensor) adapted to measure the intensity of force incurred by the touch.

The audio module 1370 may convert a sound into an electrical signal and vice versa. According to an embodiment, the audio module 1370 may obtain the sound via the input device 1350, or output the sound via the sound output device 1355 or a headphone of an external electronic device (e.g., an electronic device 1302) directly (e.g., wiredly) or wirelessly coupled with the electronic device 1301.

The sensor module 1376 may detect an operational state (e.g., power or temperature) of the electronic device 1301 or an environmental state (e.g., a state of a user) external to the electronic device 1301, and then generate an electrical signal or data value corresponding to the detected state. According to an embodiment, the sensor module 1376 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1377 may support one or more specified protocols to be used for the electronic device 1301 to be coupled with the external electronic device (e.g., the electronic device 1302) directly (e.g., wiredly) or wirelessly. According to an embodiment, the interface 1377 may include, for example, a high definition multimedia interface (HDMI), a universal serial bus (USB) interface, a secure digital (SD) card interface, or an audio interface.

A connecting terminal 1378 may include a connector via which the electronic device 1301 may be physically connected with the external electronic device (e.g., the electronic device 1302). According to an embodiment, the connecting terminal 1378 may include, for example, a HDMI connector, a USB connector, a SD card connector, or an audio connector (e.g., a headphone connector).

The haptic module 1379 may convert an electrical signal into a mechanical stimulus (e.g., a vibration or a movement) or electrical stimulus which may be recognized by a user via his tactile sensation or kinesthetic sensation. According to an embodiment, the haptic module 1379 may include, for example, a motor, a piezoelectric element, or an electric stimulator.

The camera module 1380 may capture a still image or moving images. According to an embodiment, the camera module 1380 may include one or more lenses, image sensors, image signal processors, or flashes.

The power management module 1388 may manage power supplied to the electronic device 1301. According to one embodiment, the power management module 1388 may be implemented as at least part of, for example, a power management integrated circuit (PMIC).

The battery 1389 may supply power to at least one component of the electronic device 1301. According to an embodiment, the battery 1389 may include, for example, a primary cell which is not rechargeable, a secondary cell which is rechargeable, or a fuel cell.

The communication module 1390 may support establishing a direct (e.g., wired) communication channel or a wireless communication channel between the electronic device 1301 and the external electronic device (e.g., the electronic device 1302, the electronic device 1304, or the server 1308) and performing communication via the established communication channel. The communication module 1390 may include one or more communication processors that are operable independently from the processor 1320 (e.g., the application processor (AP)) and supports a direct (e.g., wired) communication or a wireless communication. According to an embodiment, the communication module 1390 may include a wireless communication module 1392 (e.g., a cellular communication module, a short-range wireless communication module, or a global navigation satellite system (GNSS) communication module) or a wired communication module 1394 (e.g., a local area network (LAN) communication module or a power line communication (PLC) module). A corresponding one of these communication modules may communicate with the external electronic device via the first network 1398 (e.g., a short-range communication network, such as Bluetooth™, wireless-fidelity (Wi-Fi) direct, or infrared data association (IrDA)) or the second network 1399 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other.

The wireless communication module 1392 may identify and authenticate the electronic device 1301 in a communication network, such as the first network 1398 or the second network 1399, using subscriber information (e.g., international mobile subscriber identity (IMSI)) stored in the subscriber identification module 1396.

The antenna module 1397 may transmit or receive a signal or power to or from the outside (e.g., the external electronic device) of the electronic device 1301. According to an embodiment, the antenna module 1397may include an antenna including a radiating element composed of a conductive material or a conductive pattern formed in or on a substrate (e.g., PCB). According to an embodiment, the antenna module 1397 may include a plurality of antennas. In such a case, at least one antenna appropriate for a communication scheme used in the communication network, such as the first network 1398 or the second network 1399, may be selected, for example, by the communication module 1390 (e.g., the wireless communication module 1392) from the plurality of antennas. The signal or the power may then be transmitted or received between the communication module 1390 and the external electronic device via the selected at least one antenna. According to an embodiment, another component (e.g., a radio frequency integrated circuit (RFIC)) other than the radiating element may be additionally formed as part of the antenna module 1397.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1301 and the external electronic device 1304 via the server 1308 coupled with the second network 1399. Each of the electronic devices 1302 and 1304 may be a device of a same type as, or a different type, from the electronic device 1301. According to an embodiment, all or some of operations to be executed at the electronic device 1301 may be executed at one or more of the external electronic devices 1302, 1304, or 1308. For example, if the electronic device 1301 should perform a function or a service automatically, or in response to a request from a user or another device, the electronic device 1301, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1301. The electronic device 1301 may provide the outcome, with or without further processing of the outcome, as at least part of a reply to the request. To that end, a cloud computing, distributed computing, or client-server computing technology may be used, for example.

As described above, according to various embodiments, an electronic device (e.g., the electronic device 100) may include a transparent member (e.g., the cover glass 120), a display (e.g., the display 140) that is disposed under the transparent member and that includes a plurality of pixels, an image sensor (e.g., the image sensor 171c) that is disposed under at least a partial area of the display, and an optical path layer (e.g., the optical path layer 171b) that is disposed between the at least a partial area and the image sensor. The optical path layer may include an incident path of light that is formed such that, when light output through the plurality of pixels is reflected from the transparent member and an external object in contact with the transparent member, light reflected from the external object is delivered to the image sensor and light reflected from the transparent member is interrupted.

According to various embodiments, the incident path of light may be formed to be inclined at a specified angle with respect to an optical axis of the image sensor.

According to various embodiments, the specified angle may include Brewster angle (e.g., Brewster angle 451) that is determined based on the transparent layer and an air layer.

According to various embodiments, the optical path layer may include a lens (e.g., the micro lens 171b) that is eccentrically located by a specified magnitude relative to an optical axis of the image sensor and that has a masking pattern (e.g., the masking pattern 171d) applied thereto.

According to various embodiments, the optical path layer may include an opaque member (e.g., the opaque member 171f) that has a pin hole (e.g., the pin hole 171g) that is formed therein in a direction inclined at a specified angle with respect to an optical axis of the image sensor.

According to various embodiments, the optical path layer may include a transparent member (e.g., the transparent member 171h) that has a masking pattern (e.g., the masking pattern 171i) applied thereto.

According to various embodiments, the electronic device may further include a polarizing filter (e.g., the polarizer 133) that is disposed between the transparent member and the display.

As described above, according to various embodiments, an electronic device (e.g., the electronic device 100) may include a housing (e.g., the housing 110), a cover glass (e.g., the cover glass 120) that forms the exterior of at least one surface of the housing, a display (e.g., the display 140) that is located inside the housing and under the cover glass and is exposed through a first area of the cover glass, and an optical fingerprint sensor (e.g., the optical fingerprint sensor 171) that is located inside the housing and under the display and, when viewed from above the cover glass, placed in a position aligned with a second area of the cover glass that is included in the first area. The optical fingerprint sensor may include an image sensor (e.g., the image sensor 171c) and an optical path layer (e.g., the optical path layer 171b) that is located at the top of the image sensor. The optical path layer may have an incident path of light that is formed such that a chief ray angle of light (e.g., the chief ray angle 530 of the light) that is incident on the image sensor matches Brewster angle (e.g., Brewster angle 550) that is determined based on the cover glass and an air layer.

According to various embodiments, the optical path layer may include a lens (e.g., the micro lens 171b) that is eccentrically located by a specified magnitude relative to a central axis of the image sensor and that has a masking pattern (e.g., the masking pattern 171d) applied thereto, and the incident path of light may be formed by a partial area (e.g., the space 171e) of the lens in which the masking pattern is not located.

According to various embodiments, the optical path layer may include an opaque member (e.g., the opaque member 171f) that has a pin hole (e.g., the pin hole 171g) that is formed therein in a direction inclined at a specified angle with respect to a central axis of the image sensor, and the incident path of light may be formed by the pin hole.

According to various embodiments, the optical path layer may include a transparent member (e.g., the transparent member 171h) that has a masking pattern (e.g., the masking pattern 171i) applied thereto, and the incident path of light may be formed by a partial area (e.g., the space 171i) of the transparent member in which the masking pattern is not located.

According to various embodiments, the image sensor may include a plurality of first pixels (e.g., the first pixel 811 or the first pixel 1010) that correspond to the optical path layer having the incident path of light that is directed in a first direction (e.g., the first direction 851 or the first direction 1030) and a plurality of second pixels (e.g., the second pixel 813 or the second pixel 1050) that correspond to the optical path layer having the incident path of light that is directed in a second direction (e.g., the second direction 853 or the second direction 1070) that is different from the first direction.

According to various embodiments, a first virtual line in the first direction and a second virtual line in the second direction may be located on the same virtual plane.

According to various embodiments, at least one of the first pixels and the second pixels may include a plurality of sub-pixels (e.g., the first sub-pixel 1011, the second sub-pixel 1012, the third sub-pixel 1013, the fourth sub-pixel 1014, the fifth sub-pixel 1015, the sixth sub-pixel 1016, the seventh sub-pixel 1017, the eighth sub-pixel 1018, or the ninth sub-pixel 1019), and incident paths of light of the respective sub-pixels may be directed in different directions.

According to various embodiments, a direction of a second vector calculated by the sum of first vectors corresponding to the incident paths of light of the respective sub-pixels may be the same as a direction of a third vector corresponding to an incident path of light of the pixel including the sub-pixels.

As described above, according to various embodiments, an electronic device (e.g., the electronic device 100) may include a housing (e.g., the housing 110), a cover glass (e.g., the cover glass 120) that forms the exterior of at least one surface of the housing, a polarizer (e.g., the polarizer 133) that is located inside the housing and under the cover glass, a polarization direction of the polarizer being a first direction, a display (e.g., the display 140) that is located inside the housing and under the polarizer and exposed through a first area of the cover glass, and an optical fingerprint sensor (e.g., the optical fingerprint sensor 171) that is located inside the housing and under the display and, when viewed from above the cover glass, placed in a position aligned with a second area of the cover glass that is included in the first area. The optical fingerprint sensor may include an image sensor (e.g., the image sensor 171c) and an optical path layer (e.g., the optical path layer 171b) that is located at the top of the image sensor. The optical path layer may have an incident path of light that is formed such that a chief ray angle of light (e.g., the chief ray angle 530 of the light) that is incident on the image sensor matches Brewster angle (e.g., Brewster angle 550) that is determined based on the cover glass and an air layer. The image sensor may include a plurality of first pixels (e.g., the first pixel 811 or the first pixel 1010) that correspond to the optical path layer having the incident path of light that is directed in a second direction (e.g., the first direction 851 or the first direction 1030) and a plurality of second pixels (e.g., the second pixel 813 or the second pixel 1050) that correspond to the optical path layer having the incident path of light that is directed in a third direction (e.g., the second direction 853 or the second direction 1070) that is different from the second direction.

According to various embodiments, a first virtual line in the first direction, a second virtual line in the second direction, and a third virtual line in the third direction may be located on the same virtual plane.

According to various embodiments, a first virtual line in the first direction and a second virtual line in the second direction may be located on the same virtual plane, and a third virtual line in the third direction may be perpendicular to the same plane.

According to various embodiments, at least one of the first pixels and the second pixels may include a plurality of sub-pixels (e.g., the first sub-pixel 1011, the second sub-pixel 1012, the third sub-pixel 1013, the fourth sub-pixel 1014, the fifth sub-pixel 1015, the sixth sub-pixel 1016, the seventh sub-pixel 1017, the eighth sub-pixel 1018, or the ninth sub-pixel 1019), and incident paths of light of the respective sub-pixels may be directed in different directions.

According to various embodiments, a direction of a second vector calculated by the sum of first vectors corresponding to the incident paths of light of the respective sub-pixels may be the same as a direction of a third vector corresponding to an incident path of light of the pixel including the sub-pixels.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1340) including one or more instructions that are stored in a storage medium (e.g., internal memory 1336 or external memory 1338) that is readable by a machine (e.g., the electronic device 1301). For example, a processor(e.g., the processor 1320) of the machine (e.g., the electronic device 1301) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
a transparent member;
a display disposed under the transparent member, the display including a plurality of pixels;
an image sensor disposed under at least a partial area of the display; and
an optical path layer disposed between the at least a partial area and the image sensor,
wherein the optical path layer includes an incident path of light that is formed such that, when light output through the plurality of pixels is reflected from the transparent member and an external object in contact with the transparent member, light reflected from the external object is delivered to the image sensor and light reflected from the transparent member is interrupted.

2. The electronic device of claim 1, wherein the incident path of light is formed to be inclined at a specified angle with respect to an optical axis of the image sensor.

3. The electronic device of claim 2, wherein the specified angle includes Brewster angle determined based on the transparent layer and an air layer.

4. The electronic device of claim 1, wherein the optical path layer includes a lens that is eccentrically located by a specified magnitude relative to an optical axis of the image sensor and that has a masking pattern applied thereto.

5. The electronic device of claim 1, wherein the optical path layer includes an opaque member having a pin hole formed therein in a direction inclined at a specified angle with respect to an optical axis of the image sensor.

6. The electronic device of claim 1, wherein the optical path layer includes a transparent member having a masking pattern applied thereto.

7. The electronic device of claim 1, further comprising:
a polarizing filter disposed between the transparent member and the display.

8. An electronic device comprising:
a housing;
a cover glass configured to form the exterior of at least one surface of the housing;
a display located inside the housing and under the cover glass and exposed through a first area of the cover glass; and
an optical fingerprint sensor located inside the housing and under the display and, when viewed from above the cover glass, placed in a position aligned with a second area of the cover glass that is included in the first area,
wherein the optical fingerprint sensor includes an image sensor and an optical path layer located at the top of the image sensor, and
wherein the optical path layer has an incident path of light that is formed such that a chief ray angle (CRA) of light incident on the image sensor matches Brewster angle determined based on the cover glass and an air layer.

9. The electronic device of claim 8, wherein the optical path layer includes a lens that is eccentrically located by a specified magnitude relative to a central axis of the image sensor and that has a masking pattern applied thereto, and
wherein the incident path of light is formed by a partial area of the lens in which the masking pattern is not located.

10. The electronic device of claim 8, wherein the optical path layer includes an opaque member having a pin hole formed therein in a direction inclined at a specified angle with respect to a central axis of the image sensor, and
wherein the incident path of light is formed by the pin hole.

11. The electronic device of claim 8, wherein the optical path layer includes a transparent member having a masking pattern applied thereto, and
wherein the incident path of light is formed by a partial area of the transparent member in which the masking pattern is not located.

12. The electronic device of claim 8, wherein the image sensor includes:
a plurality of first pixels corresponding to the optical path layer having the incident path of light that is directed in a first direction; and
a plurality of second pixels corresponding to the optical path layer having the incident path of light that is directed in a second direction different from the first direction.

13. The electronic device of claim 12, wherein a first virtual line in the first direction and a second virtual line in the second direction are located on the same virtual plane.

14. The electronic device of claim 12, wherein at least one of the first pixels and the second pixels includes a plurality of sub-pixels, and
wherein incident paths of light of the respective sub-pixels are directed in different directions.

15. The electronic device of claim 14, wherein a direction of a second vector calculated by the sum of first vectors corresponding to the incident paths of light of the respective sub-pixels is the same as a direction of a third vector corresponding to an incident path of light of the pixel including the sub-pixels.
